(19) United States
(12) Patent Application Publication
(10) Pub. No.: US 2008/0002119 A1
(43) Pub. Date: Jan. 3, 2008

(54) Method of cutting rubbing cloth and method of forming alignment layer in liquid crystal display device

(76) Inventor: Ki-Chan Sung, Paju (KR)

Correspondence Address: MCKENNA LONG & ALDRIDGE LLP, 1900 K STREET, NW, WASHINGTON, DC, 20006, US

(21) Appl. No.: 11/639,327

(22) Filed: Dec. 15, 2006

(30) Foreign Application Priority Data
Jun. 29, 2006 (KR) 10-2006-059964

(51) Int. Cl. G02F 1/1337

(52) U.S. Cl. 349/126

(57) ABSTRACT

A method of cutting a rubbing cloth is disclosed, which includes: providing a rubbing cloth to rub a substrate including a plurality of active areas and dummy areas at a circumference of the active areas; dividing the rubbing cloth into a plurality of cutting areas to correspond to the substrate; and froming a plurality of cutting lines to divide the cutting areas into the plurality of areas by cutting the rubbing cloth several times, wherein a position of each meeting point of the curring lines is controlled to dispose the meeting point in the dummy area.

This application claims the benefit of Korean Patent Application No. 10-2006-059964, filed on Jun. 29, 2006, which is hereby incorporated by reference for all purposes as if fully set forth herein.

### BACKGROUND OF THE INVENTION

1. Field of the Invention

The present invention relates to a liquid crystal display (LCD) device, and more particularly, to a method of cutting a rubbing cloth and a method of forming an alignment layer using the same.

2. Description of the Related Art

An increasing demand for flat panel display devices that have a thin profile and are lightweight currently exists because of the development of various mobile electronic equipment, for example, mobile phones, PDAs, and notebook computers. These flat panel display devices may include a liquid crystal display (LCD), a plasma display panel (PDP), a field emission display (FED), or a vacuum fluorescent display (VFD). Particularly, LCD devices are advantageous because they are relatively easily mass-produced, have high picture quality and have good mobility.

FIG. 1 is a cross sectional view of a related art LCD device. As shown in FIG. 1, the related art LCD device includes a first substrate 5, a second substrate 3, and a liquid crystal layer 7 formed between the first substrate 5 and the second substrate 3.

The first substrate 5 is provided with a thin film transistor (TFT) that functions as a driving element. The first substrate 5 includes a plurality of pixel regions (not shown), wherein each pixel region has a TFT. The second substrate 3 is provided with a color filter layer that includes layers that form various colors. Also, the first substrate 5 includes a pixel electrode (not shown) and the second substrate 3 includes a common electrode (not shown). Each of the first and second substrates 5 and 3 is coated with an alignment layer that aligns liquid crystal molecules in the liquid crystal layer 7. The first and second substrates 5 and 3 are bonded to each other by a sealant 9.

The liquid crystal molecules in the liquid crystal layer 7 are driven by the driving element formed on the first substrate 5. Accordingly, information is displayed by controlling the amount of light passing through the liquid crystal layer 7.

A method of fabricating the related art LCD device includes: a TFT array substrate process of forming the driving element on the first substrate 5; a color filter array substrate process of forming the color filter on the second substrate 3; and a cell process that is explained with reference to FIG. 2.

For the TFT array substrate process, a plurality of gate lines and data lines are formed on the first substrate 5, thereby defining the plurality of pixel regions. A TFT is formed in each pixel region, and the TFT functions as a driving element connected with the gate lines and data lines (S101). Also, a pixel electrode is connected to a TFT through the TFT array substrate process. Thus, the liquid crystal layer is driven based on a signal applied through the TFT.

Through the color filter array substrate process, an RGB color filter layer that represents color and a common electrode are formed on the second substrate 3 (S104). Thereafter, an alignment layer is coated onto each of the first and second substrate 5 and 3 and is then rubbed so as to enable the alignment controlling force and the surface fixation force of the alignment layer. The alignment controlling force controls the liquid crystal molecules of the liquid crystal layer and the surface fixation force controls the pretilt angle and alignment direction of the liquid crystal molecules (S102, S105). Then, after spacers are scattered on the first substrate 5 so as to maintain a cell gap between the two substrates, a sealant is formed in the circumference of the second substrate 3, and the first and second substrates are bonded to each other by applying a pressure to the sealant (S103, S106, S107). Each of the first and second substrates 5 and 3 may be formed from a large-sized substrate. That is, a plurality of panel areas are formed on the large-sized substrate, and the TFT and the color filter layer are formed in each panel area. The large-sized substrate is cut into each LCD panel area and is processed (S108). Then, liquid crystal is injected into each LCD panel through the use of an inlet, and then the inlet is sealed. Thus, a liquid crystal layer is formed (S109). After that, an inspection is performed on each LCD panel (S110), thereby completing the related art LCD device.

During the process of fabricating the related art LCD device, the alignment layer is formed on the substrate, and then the rubbing process is performed on the alignment layer to determine the alignment direction. The alignment layer is formed by depositing a thin film at a constant thickness by coating a polymer material on the substrate. Generally, the alignment layer may be formed of an organic material, for example, a polyimide-based material.

The alignment layer formed on the substrate is rubbed by a rubbing cloth. Through the rubbing process, micro-grooves are formed in the alignment layer. Accordingly, the liquid crystal molecules are aligned in a predetermined direction along the micro-grooves.

FIG. 3 illustrates a related art rubbing process to rub the alignment layer. For the rubbing process, as shown in FIG. 3, a rubbing roller 20 having the rubbing cloth 22 wound thereon rolls on the substrate 3 coated with the alignment layer 13. At this time, the rubbing roller 20 is positioned at one side of the substrate 3 and is then moved along the substrate 3, whereby the alignment layer 13 is rubbed by the rubbing cloth 22. That is, the micro-grooves are formed in the entire surface of the substrate 3.

In order to rub the entire surface of the alignment layer, it is necessary to use the rubbing cloth having a size appropriate for and corresponding to the substrate.

Based on the size of a particular LCD device, the substrate of the LCD device varies in size. To use a rubbing cloth having an appropriate and corresponding size, the rubbing cloth must be cut by a cutter. That is, it is necessary to cut the rubbing cloth so that it is the appropriate size based on the width of the substrate and the circumference of the rubbing roller having the rubbing cloth wound thereon.

To use the rubbing cloth having the appropriate size based on the width of the substrate and the circumference of the rubbing roller, it is necessary to cut the rubbing cloth to the appropriate size according to the size of the substrate and the kind of the rubbing roller. Related art cutters used to cut the rubbing cloth have restricted ranges of cutting length. Especially, if the rubbing cloth is large-sized, it is impossible to cut the rubbing cloth at one time.

As shown in FIG. 4, when cutting the rubbing cloth in the length direction of the rubbing roller, the cutter has a restricted cutting length range. Thus, a first cutting line 23a is formed by cutting a predetermined portion of the rubbing cloth 22, and then a second cutting line 23b is formed by cutting the remaining portion of the rubbing cloth 22, wherein the second cutting line 23b meets the first cutting line 23a.

However, it is difficult to make the endpoints of the first and second cutting lines 23a and 23b accurately meet at one point. Thus, the rubbing cloth may come off from the meeting point (A) of the first and second cutting lines 23a and 23b. This may cause a rubbing scratch in the alignment layer. Thus, after the rubbing process, the liquid crystal molecules positioned above the alignment layer may not be aligned uniformly due to the rubbing scratch of the alignment layer.

To prevent the defective rubbing of the related art, it is necessary to prevent a rubbing cloth from coming off of a meeting point of cutting lines during a rubbing-cloth cutting process. To prevent this, the rubbing cloth may be cut out at one time or the two endpoints of the cutting lines may accurately meet at one point.

However, because rubbing clothes are large-sized, it is difficult to cut the rubbing cloth at one time. Also, it is difficult to make the endpoints of the cutting lines accuratley meet at one point.

### SUMMARY OF THE INVENTION

Accordingly, the present invention is directed to a method of cutting a rubbing cloth and a method of forming an alignment layer in a liquid crystal display (LCD) device that substantially obviates one or more of the problems due to limitations and disadvantages of the related art.

An advantage of the present invention is to provide a method of cutting a rubbing cloth, in which a meeting point of cutting lines is positioned in a dummy area of a substrate during a rubbing-cloth cutting process, thereby preventing defective rubbing.

Additional features and advantages of the invention will be set forth in the description which follows, and in part will be apparent from the description, or may be learned by practice of the invention. These and other advantages of the invention will be realized and attained by the methods particularly pointed out in the written description and claims hereof as well as the appended drawings.

To achieve these and other advantages and in accordance with the purpose of the present invention, as embodied and broadly described, a method of cutting a rubbing cloth includes: providing a rubbing cloth to rub a substrate including a plurality of active areas and dummy areas at a circumference of the active areas; dividing the rubbing cloth into a plurality of cutting areas to correspond to the substrate; and forming a plurality of cutting lines to divide the cutting areas into the plurality of areas by cutting the rubbing cloth several times, wherein a position of each meeting point of the cutting lines is controlled to locate the meeting point in the dummy area when rubbing the substrate.

In another aspect of the present invention, a method of forming an alignment layer includes: forming an alignment layer on a substrate including a plurality of active areas and dummy areas at a circumference of the active areas; providing a rubbing cloth to rub the alignment layer; dividing the rubbing cloth into a plurality of areas to correspond to the substrate; separating the plurality of areas of the rubbing cloth by cutting the rubbing cloth several times such that each meeting point of cutting lines is positioned in the dummy area; winding the separated rubbing cloth on a rubbing roller; and rubbing the alignment layer using the rubbing roller having the rubbing cloth wound thereon.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a cross sectional view of a related art LCD device;

FIG. 2 is a flow chart illustrating a method for fabricating a related art LCD device;

FIG. 3 illustrates a view of a related art rubbing method;

FIG. 4 illustrates a view of cutting a rubbing cloth and a rubbing roller according to the related art;

FIG. 5 illustrates a view of a rubbing cloth and a rubbing roller of the present invention; and

FIG. 6 illustrates a view of a rubbing roller having a rubbing cloth wound thereon.

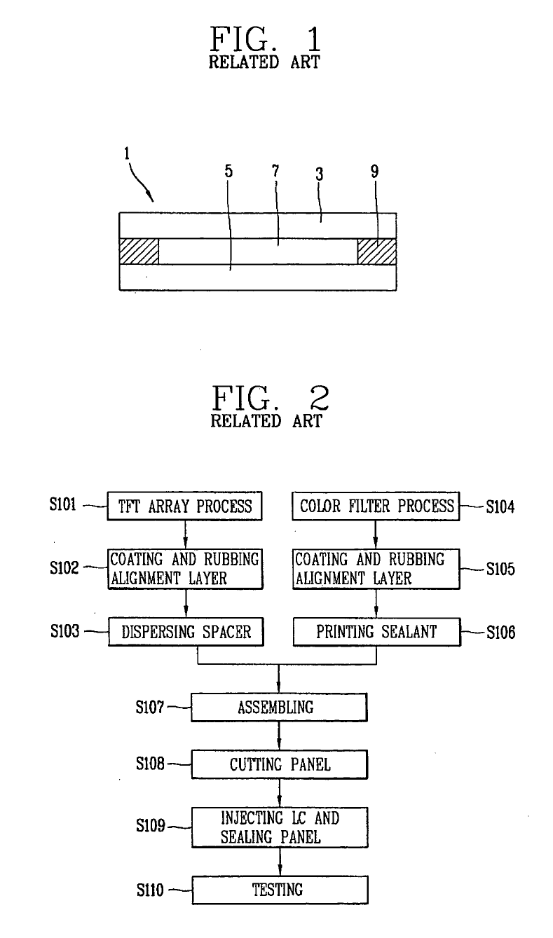

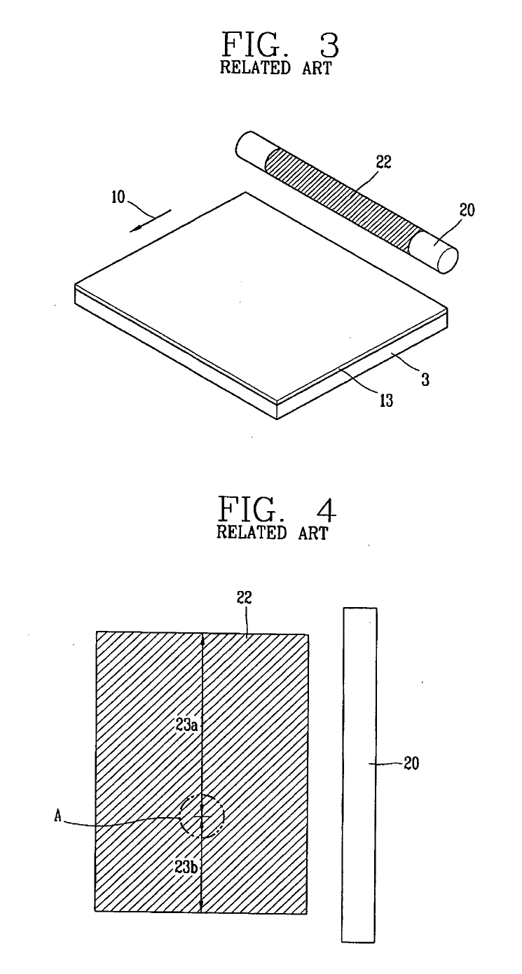

### DETAILED DESCRIPTION OF THE ILLUSTRATED EMBODIMENTS

Reference will now be made in detail to embodiments of the present invention, examples of which are illustrated in the accompanying drawings.

The present invention uses a simplified method that may prevent defective rubbing in the meeting point of the cutting lines. In the present invention, the uneven portion of the rubbing cloth is positioned in an area where the image is not displayed, thereby preventing a deteriorated picture quality. Although endeavors to prevent the rubbing cloth from coming off and being uneven in the meeting point of the cutting lines have been made, the present invention adjusts the uneven portion of the rubbing cloth in position. That is, the uneven portion of the rubbing cloth is positioned in the outside of the image-display area. Thus, it is unnecessary in the present invention to provide a new device or method of cutting the rubbing cloth, which may incur additional fabrication costs.

Accordingly, a rubbing cloth is first divided into a plurality of areas based on the corresponding substrate to be rubbed and is cut on the areas. The cutting length of the related art rubbing-cloth cutter is limited and the maximum cutting length can not be adjusted. However, the cutting method of the present invention can adjust the position of cutting line to cut the rubbing cloth. Here, the rubbing cloth is divided into areas that correspond to the rubbing-cloth adjusting process so as to position the endpoints of the cutting lines in a dummy area of the substrate.

The dummy area of the substrate may correspond to the area in which the image is not displayed. An LCD device substrate according to the present invention includes an active area that corresponds to an LCD panel after cutting the substrate and a dummy area formed at the circumference of the active area in which an image is not displayed. The dummy area is formed in the circumference of the active area.

In the present invention, the meeting point of the cutting lines of the rubbing cloth is positioned in the dummy area. Thus, even though the rubbing cloth may come off at the meeting point of the cutting lines, it is possible to prevent defective rubbing in the active area where an image is displayed.

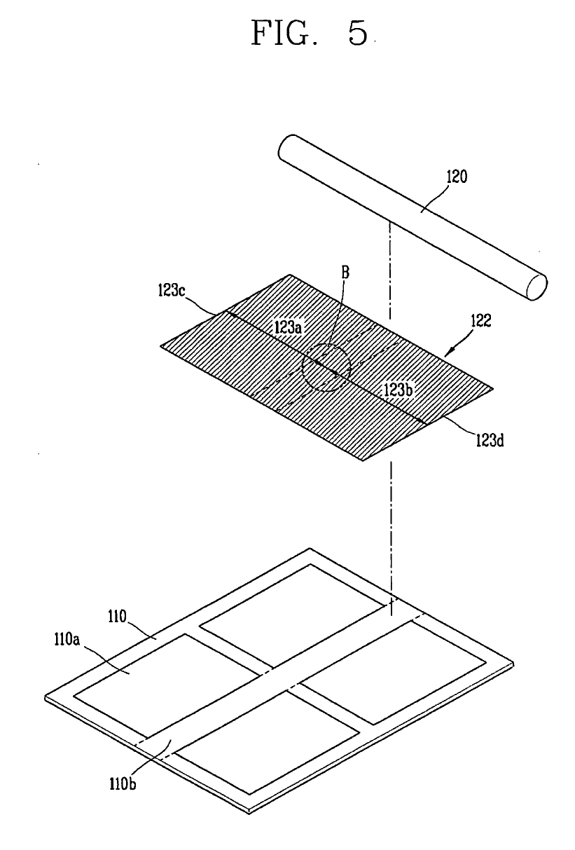

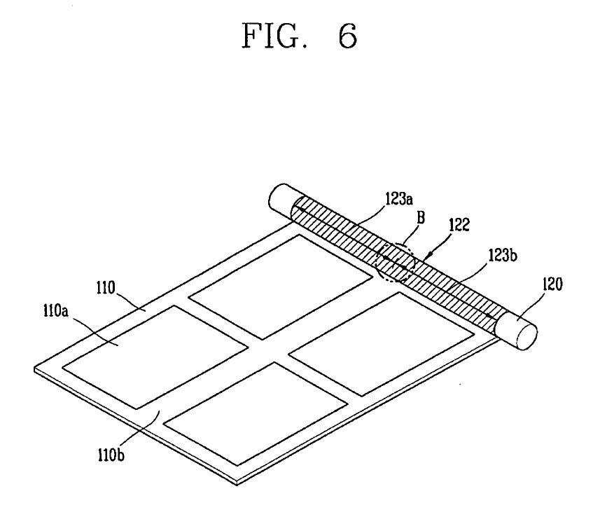

FIGS. 5 and 6 illustrate the rubbing cloth according to the present invention. FIG. 5 illustrates a rubbing roller having no rubbing cloth and FIG. 6 illustrates a rubbing roller having a rubbing cloth wound thereon.

In FIGS. 5 and 6, a substrate is coated with an alignment layer (not shown), and the alignment layer is rubbed by the rubbing cloth. A substrate 110 includes an active area 110a that displays an image and a dummy area 110b that is positioned at the circumference of the active area 110. An image is not displayed in the dummy area 110b.

The width of the rubbing cloth 122 wound on the rubbing roller 120 may be identical to or larger than the entire width of the substrate 110. Also, the length of the rubbing cloth 122 wound on the rubbing roller 120 may be identical to or smaller than the circumference of the rubbing roller 120. However, because the rubbing cloth 122 is generally larger than the substrate 110, the rubbing cloth 122 is first cut and then wound on the rubbing roller 120. It is difficult to cut the rubbing cloth 122 at one time. Thus, the rubbing cloth 122 is cut in several steps.

As shown in FIG. 5, when winding the rubbing cloth 122 on the rubbing roller 120, third and fourth cutting lines 123c and 123d positioned in the margin of the rubbing cloth 122 are formed in the margin of the substrate 110, that is, the exterior of the active area 110a in which the image is displayed. Even though the endpoints of the first and second cutting lines 123a and 123b don't meet at one accurate point, it is possible to prevent defective rubbing caused by uneven portions of the rubbing cloth in the active area of the substrate.

The rubbing cloth 122 is cut on first and second cutting lines 123a and 123b so as to make the length of the rubbing cloth 122 correspond to the circumference of the rubbing roller 120. The meeting point (B) of the first and second lines 123a and 123b is positioned at an interior area of the rubbing roller 120, where the rubbing cloth 122 is wound on the rubbing roller 120, as shown in FIG. 6. If the substrate 110 is rubbed by the rubbing roller 120, the defective rubbing may occur due to the rubbing scratch along the rubbing direction.

To remove the rubbing scratch, the endpoints of the first and second cutting lines 123a and 123b, that is, the meeting point (B) of the first and second cutting lines 123a and 123b, is positioned in the dummy area 110b of the substrate 110. That is, when cutting the rubbing cloth 122, the rubbing cloth is divided into two areas. Then, the rubbing cloth 122 is partially cut at the point corresponding to the dummy area 110b and is then cut in the remaining portion. As a result, the meeting point (B) of the two cutting lines is positioned in the dummy area of the substrate on the rubbing process. Accordingly, the meeting point (B) of the two cutting lines does not cause bad effects in the active area 110a.

In the drawings, only four active areas 100a, i.e, 2×2 active areas 100a, are formed in the substrate. However, the present invention applies to substrates having more than four active areas. That is, active areas having 2×2 structures may be formed in the substrate 110 in this invention. Thus, a plurality of dummy areas 110b is formed in the central region of the substrate 110. That is, the meeting point B of the cutting line of the rubbing cloth may be disposed at at least one of the dummy areas of a plurality of dummy areas 110b by controlling the cutting length of the rubbing cloth. Further, a plurality of meeting points B of the cutting line of the rubbing cloth 122 are disposed at dummy areas 110b.

The method of cutting the rubbing cloth to rub the substrate includes preparing the rubbing cloth, dividing the rubbing cloth that rubs the substrate into a plurality of areas, cutting a predetermined portion of the rubbing cloth using a cutter, and cutting the remaining portion of the rubbing cloth using the cutter.

The method of cutting the rubbing cloth according to the present invention has the following advantages. In the method of cutting the rubbing cloth according to the present invention, it is possible to prevent defective rubbing of the rubbing scratch caused by the occurence of the meeting point of the cutting lines of the rubbing cloth in the active area of the substrate. Thus, it is possible to prevent picture quality from being deteriorated.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of cutting a rubbing cloth comprising:
providing a rubbing cloth to rub a substrate including a plurality of active areas and dummy areas at a circumference of the active areas;
dividing the rubbing cloth into a plurality of cutting areas to correspond to the substrate; and
forming a plurality of cutting lines to divide the cutting areas into the plurality of areas by cutting the rubbing cloth several times,
wherein a position of each meeting point of the cutting lines is controlled to locate the meeting point in the dummy area when rubbing the substrate.

2. The method of claim 1, wherein dividing the rubbing cloth includes controlling the length of the cutting lines of the rubbing cloth to be cut.

3. The method of claim 1, wherein the meeting point of the cutting lines is positioned in the dummy area at an inner part of the substrate.

4. The method of claim 1, wherein forming the plurality of cutting lines includes:
forming a first cutting line by cutting the rubbing cloth; and
forming a second cutting line by cutting the rubbing cloth, the second cutting line being contiguous with the first cutting line.

5. The method of claim 1, wherein the plurality of dummy areas are formed at an inside part of the substrate.

6. The method of claim 5, wherein the meeting point of the cutting lines of the rubbing cloth is positioned in each of the dummy areas.

7. The method of claim 5, wherein the meeting point of the cutting lines of the rubbing cloth is positioned in at least one of the dummy areas.

8. A method of forming an alignment layer, comprising:
forming an alignment layer on a substrate including a plurality of active areas and dummy areas at a circumference of the active areas;
providing a rubbing cloth to rub the alignment layer;
dividing the rubbing cloth into a plurality of areas to correspond to the substrate;
separating the plurality of areas of the rubbing cloth by cutting the rubbing cloth several times such that each meeting point of cutting lines is positioned in the dummy area;
winding the separated rubbing cloth on a rubbing roller; and
rubbing the alignment layer using the rubbing roller having the rubbing cloth.

9. The method of claim 8, wherein the meeting point of the cutting lines of the rubbing cloth is positioned in the dummy area at an inside part of the substrate.

10. The method of claim 8, wherein dividing the rubbing cloth includes:
forming a first cutting line by cutting the rubbing cloth; and
forming a second cutting line in connection with the first cutting line by cutting the rubbing cloth.

11. The method of claim 8, wherein rubbing the alignment layer includes:
positioning the rubbing roller at one side of the substrate; and
rolling the rubbing roller on the substrate while the substrate is moving, thereby moving the rubbing roller to the other side of the substrate.

12. The method of claim 11, wherein a rubbing scratch of the alignment layer, caused by the meeting point of the cutting lines of the rubbing cloth, is formed in the dummy area of the substrate.

13. The method of claim 8, wherein the substrate is a color filter array substrate.

14. The method of claim 8, wherein the substrate is a TFT array substrate.

15. The method of claim 8, further including forming micro-grooves in the substrate.

16. The method of claim 8, wherein the plurality of active areas are formed in a 2×2 matrix.
